(19) United States
(12) Patent Application Publication
(10) Pub. No.: US 2024/0171927 A1
(43) Pub. Date: May 23, 2024

(54) Interactive Audio Rendering of a Spatial Stream

(71) Applicant: Nokia Technologies Oy, Espoo (FI)

(72) Inventors: Mikko-Ville LAITINEN, Espoo (FI); Juha Tapio VILKAMO, Helsinki (FI)

(21) Appl. No.: 18/283,493

(22) PCT Filed: Feb. 25, 2022
(86) PCT No.: PCT/FI2022/050125

§ 371 Date: Sep. 22, 2023

(30) Foreign Application Priority Data
Mar. 26, 2021 (GB) 2104309.6

(51) Int. Cl. H04S 7/00

(52) U.S. Cl. CPC H04S 7/30; H04S 2420/03

(57) ABSTRACT

An apparatus for processing at least two audio signals and associated metadata, the apparatus including circuitry configured to: obtain the audio signals, the audio signals including at least one audio object portion and at least one non-audio object portion; obtain the associated metadata, wherein the associated metadata is configured to define at least one audio object position and at least one audio object energy proportion; obtain object position control information; determine mixing information based on the object position control information and the at least one audio object position and at least one audio object energy proportion; and process the at least two audio signals based on the mixing information, wherein the processing is configured to enable the at least one object portion of a first of the at least two audio signals to be at least partially moved to a second of the at least two audio signals.

### FIELD

The present application relates to apparatus and methods for interactive audio rendering of a spatial stream, but not exclusively for interactive audio rendering of a spatial stream for mobile phone systems.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources.

Input signals can be presented to the IVAS encoder in one of a number of supported formats (and in some allowed combinations of the formats). For example a mono audio signal (without metadata) may be encoded using an Enhanced Voice Service (EVS) encoder. Other input formats may utilize new IVAS encoding tools. One input format proposed for IVAS is the Metadata-assisted spatial audio (MASA) format, where the encoder may utilize, e.g., a combination of mono and stereo encoding tools and metadata encoding tools for efficient transmission of the format.

The use of “Audio objects” is another example of an input format proposed for IVAS. In this input format the scene is defined by a number (1 to N) of audio objects (where N is, e.g., 5). Each of the objects have an individual audio signal and some metadata describing its (spatial) features. The metadata may be a parametric representation of audio object and may include such parameters as the direction of the audio object (e.g., azimuth and elevation angles). Other examples include the distance, the spatial extent, and the gain of the object.

IVAS is being planned to support combinations of inputs. As an example, there may be a combination of a MASA input with an audio object(s) input. IVAS should be able to transmit them both simultaneously.

As the IVAS codec is expected to operate on various bit rates ranging from very low bit rates (about 13 kb/s) to relatively high bit rates (about 500 kb/s), various strategies are needed for the compression of the audio signals and the spatial metadata. For example, in the case where the input comprises multiple objects and MASA input streams, there are several audio channels to transmit. This can therefore create a situation where, especially at lower bitrates, it may not be possible to transmit all the audio signals separately, but instead as a downmix.

However, being able to interact with the objects may be a desirable feature. For example listener A may want to position an audio object to the left, whereas listener B may want to position the same audio object to the right. Thus, rendering systems implementing codecs such as the above should be able to perform an interaction within the decoder/renderer so that each listener can have an individual experience. Where each audio object cannot be transmitted separately (for example in low bit rate situations) such an interactive rendering of the objects is not a trivial operation.

### SUMMARY

There is provided according to a first aspect an apparatus for processing at least two audio signals and associated metadata, the apparatus comprising means configured to: obtain the at least two audio signals, the at least two audio signals comprising at least one audio object portion and at least one non-audio object portion; obtain the associated metadata, wherein the associated metadata is configured to define at least one audio object position and at least one audio object energy proportion; obtain object position control information; determine mixing information based on the object position control information and the at least one audio object position and at least one audio object energy proportion; and process the at least two audio signals based on the mixing information, wherein the processing is configured to enable the at least one object portion of a first of the at least two audio signals to be at least partially moved to a second of the at least two audio signals.

The object position control information may comprise a modified position of the at least one audio object, and the means configured to determine the mixing information based on the object position control information and the at least one audio object position and at least one audio object energy proportion may be configured to determine the mixing information based on the at least one audio object position and at least one audio object energy proportion and the modified position of the at least one audio object.

The means configured to determine the mixing information based on the object position control information and the at least one audio object position and at least one audio object energy proportion may be configured to determine at least one first mixing value based on the at least two audio signals, the object position control information and the at least one audio object position and at least one audio object energy proportion.

The means may be further configured to process the at least two audio signals based on the at least one first mixing value.

The means configured to determine the mixing information based on the object position control information and the at least one audio object position and at least one audio object energy proportion may be configured to determine at least one second mixing value based on the processed at least two audio signals, the object position control information and the at least one audio object position and at least one audio object energy proportion.

The means configured to determine the mixing information based on the object position control information and the at least one audio object position and at least one audio object energy proportion may be configured to determine at least one second mixing value based on the at least two audio signals, the at least one first mixing value, the object position control information and the at least one audio object position and at least one audio object energy proportion.

The means configured to process the at least two audio signals based on the mixing information, wherein the processing is configured to enable the at least one object portion of the first of the at least two audio signals to be at least partially moved to a second of the at least two audio signals may be configured to: generate a new first of the at least two audio signals based on combination of a first mixing information value applied to the first of the at least two audio signals and a second mixing information value applied to the second of the at least two audio signals; and generate a new second of the at least two audio signals based on a third mixing information value applied to the second of the at least two audio signals.

The means configured to process the at least two audio signals based on the mixing information, wherein the processing is configured to enable the at least one object portion of the first of the at least two audio signals to be at least partially moved to a second of the at least two audio signals may be configured to: generate a new first of the at least two audio signals based on combination of a first mixing information value applied to the first of the at least two audio signals and a second mixing information value applied to the second of the at least two audio signals; and generate a new second of the at least two channels based on combination of a third mixing information value applied to the first of the at least two audio signals and a fourth mixing information value applied to the second of the at least two audio signals.

The means configured to process the at least two audio signals based on the mixing information configured to enable the at least one object portion of the first of the at least two audio signals to be at least partially moved to a second of the at least two audio signals may be further configured such that the at least one non-object portion of the first of the at least two audio signals is not substantially moved.

The means configured to process the at least two audio signals based on the mixing information configured such that the at least one non-object portion of the first of the at least two audio signals is not substantially moved may be configured to determine energetic moving and preserving values based on remainder energy values.

The means may be configured to determine remainder energy values based on at least one of: normalised object energy values determined from the at least two audio signals; and energy values within the associated metadata.

The at least two audio signals may be at least two transport audio signals. The means configured to obtain at least one metadata associated with the at least two audio signals, wherein the at least one metadata is configured to define at least one audio object position and at least one audio object energy proportion may be configured to perform at least one of: obtain information defining the at least one audio object position, wherein at least one audio object energy proportion associated with the at least one audio object position can be determined based on at least one further audio object energy proportion; obtain at least one parameter value defining the at least one audio object position and at least one audio object energy proportion, wherein at least one audio object energy proportion associated with the at least one audio object position can be determined based on at least one further audio object energy proportion; receive information defining the at least one audio object position and at least one audio object energy proportion associated with the at least one object; and receive at least one parameter value defining the at least one audio object position and at least one audio object energy proportion associated with the at least one object.

The at least two audio signals may comprise at least two channels of a spatial audio signal.

According to a second aspect there is provided a method for an apparatus for processing at least two audio signals and associated metadata, the method comprising: obtaining the at least two audio signals, the at least two audio signals comprising at least one audio object portion and at least one non-audio object portion; obtaining the associated metadata, wherein the associated metadata is configured to define at least one audio object position and at least one audio object energy proportion; obtaining object position control information; determining mixing information based on the object position control information and the at least one audio object position and at least one audio object energy proportion; and processing the at least two audio signals based on the mixing information, wherein the processing enables the at least one object portion of a first of the at least two audio signals to be at least partially moved to a second of the at least two audio signals.

The object position control information may comprise a modified position of the at least one audio object, and determining the mixing information based on the object position control information and the at least one audio object position and at least one audio object energy proportion may comprise determining the mixing information based on the at least one audio object position and at least one audio object energy proportion and the modified position of the at least one audio object. Determining the mixing information based on the object position control information and the at least one audio object position and at least one audio object energy proportion may comprise determining at least one first mixing value based on the at least two audio signals, the object position control information and the at least one audio object position and at least one audio object energy proportion.

The method may further comprise processing the at least two audio signals based on the at least one first mixing value.

Determining the mixing information based on the object position control information and the at least one audio object position and at least one audio object energy proportion may comprise determining at least one second mixing value based on the processed at least two audio signals, the object position control information and the at least one audio object position and at least one audio object energy proportion.

Determining the mixing information based on the object position control information and the at least one audio object position and at least one audio object energy proportion may comprise determining at least one second mixing value based on the at least two audio signals, the at least one first mixing value, the object position control information and the at least one audio object position and at least one audio object energy proportion.

Processing the at least two audio signals based on the mixing information, wherein processing enables the at least one object portion of the first of the at least two audio signals to be at least partially moved to a second of the at least two audio signals may comprise: generating a new first of the at least two audio signals based on combination of a first mixing information value applied to the first of the at least two audio signals and a second mixing information value applied to the second of the at least two audio signals; and generating a new second of the at least two audio signals based on a third mixing information value applied to the second of the at least two audio signals.

Processing the at least two audio signals based on the mixing information, wherein processing enables the at least one object portion of the first of the at least two audio signals to be at least partially moved to a second of the at least two audio signals may comprise: generating a new first of the at least two audio signals based on combination of a first mixing information value applied to the first of the at least two audio signals and a second mixing information value applied to the second of the at least two audio signals; and generating a new second of the at least two channels based on combination of a third mixing information value applied to the first of the at least two audio signals and a fourth mixing information value applied to the second of the at least two audio signals.

Processing the at least two audio signals based on the mixing information enabling the at least one object portion of the first of the at least two audio signals to be at least partially moved to a second of the at least two audio signals may be such that the at least one non-object portion of the first of the at least two audio signals is not substantially moved.

Processing the at least two audio signals based on the mixing information configured such that the at least one non-object portion of the first of the at least two audio signals is not substantially moved may comprise determining energetic moving and preserving values based on remainder energy values.

The method may comprise determining remainder energy values based on at least one of: normalised object energy values determined from the at least two audio signals; and energy values within the associated metadata.

The at least two audio signals may be at least two transport audio signals.

Obtaining at least one metadata associated with the at least two audio signals, wherein the at least one metadata is configured to define at least one audio object position and at least one audio object energy proportion may comprise at least one of: obtaining information defining the at least one audio object position, wherein at least one audio object energy proportion associated with the at least one audio object position can be determined based on at least one further audio object energy proportion; obtaining at least one parameter value defining the at least one audio object position and at least one audio object energy proportion, wherein at least one audio object energy proportion associated with the at least one audio object position can be determined based on at least one further audio object energy proportion; receiving information defining the at least one audio object position and at least one audio object energy proportion associated with the at least one object; and receiving at least one parameter value defining the at least one audio object position and at least one audio object energy proportion associated with the at least one object.

The at least two audio signals may comprise at least two channels of a spatial audio signal.

According to a third aspect there is provided an apparatus for processing at least two audio signals and associated metadata, the apparatus comprising at least one processor and at least one memory including a computer program code, the at least one memory and the computer program code configured to, with the at least one processor, cause the apparatus at least to: obtain the at least two audio signals, the at least two audio signals comprising at least one audio object portion and at least one non-audio object portion; obtain the associated metadata, wherein the associated metadata is configured to define at least one audio object position and at least one audio object energy proportion; obtain object position control information; determine mixing information based on the object position control information and the at least one audio object position and at least one audio object energy proportion; and process the at least two audio signals based on the mixing information, wherein the processing is configured to enable the at least one object portion of a first of the at least two audio signals to be at least partially moved to a second of the at least two audio signals.

The object position control information may comprise a modified position of the at least one audio object, and the apparatus caused to determine the mixing information based on the object position control information and the at least one audio object position and at least one audio object energy proportion may be caused to determine the mixing information based on the at least one audio object position and at least one audio object energy proportion and the modified position of the at least one audio object.

The apparatus caused to determine the mixing information based on the object position control information and the at least one audio object position and at least one audio object energy proportion may be caused to determine at least one first mixing value based on the at least two audio signals, the object position control information and the at least one audio object position and at least one audio object energy proportion.

The apparatus may be further caused to process the at least two audio signals based on the at least one first mixing value.

The apparatus caused to determine the mixing information based on the object position control information and the at least one audio object position and at least one audio object energy proportion may be caused to determine at least one second mixing value based on the processed at least two audio signals, the object position control information and the at least one audio object position and at least one audio object energy proportion.

The apparatus caused to determine the mixing information based on the object position control information and the at least one audio object position and at least one audio object energy proportion may be caused to determine at least one second mixing value based on the at least two audio signals, the at least one first mixing value, the object position control information and the at least one audio object position and at least one audio object energy proportion.

The apparatus caused to process the at least two audio signals based on the mixing information, wherein the processing is configured to enable the at least one object portion of the first of the at least two audio signals to be at least partially moved to a second of the at least two audio signals may be caused to: generate a new first of the at least two audio signals based on combination of a first mixing information value applied to the first of the at least two audio signals and a second mixing information value applied to the second of the at least two audio signals; and generate a new second of the at least two audio signals based on a third mixing information value applied to the second of the at least two audio signals.

The apparatus caused to process the at least two audio signals based on the mixing information, wherein the processing is configured to enable the at least one object portion of the first of the at least two audio signals to be at least partially moved to a second of the at least two audio signals may be caused to: generate a new first of the at least two audio signals based on combination of a first mixing information value applied to the first of the at least two audio signals and a second mixing information value applied to the second of the at least two audio signals; and generate a new second of the at least two channels based on combination of a third mixing information value applied to the first of the at least two audio signals and a fourth mixing information value applied to the second of the at least two audio signals.

The apparatus caused to process the at least two audio signals based on the mixing information configured to enable the at least one object portion of the first of the at least two audio signals to be at least partially moved to a second of the at least two audio signals may be further configured such that the at least one non-object portion of the first of the at least two audio signals is not substantially moved.

The apparatus caused process the at least two audio signals based on the mixing information configured such that the at least one non-object portion of the first of the at least two audio signals is not substantially moved may be caused to determine energetic moving and preserving values based on remainder energy values.

The apparatus may be caused to determine remainder energy values based on at least one of: normalised object energy values determined from the at least two audio signals; and energy values within the associated metadata.

The at least two audio signals may be at least two transport audio signals. The apparatus caused to obtain at least one metadata associated with the at least two audio signals, wherein the at least one metadata is configured to define at least one audio object position and at least one audio object energy proportion may be caused to perform at least one of: obtain information defining the at least one audio object position, wherein at least one audio object energy proportion associated with the at least one audio object position can be determined based on at least one further audio object energy proportion; obtain at least one parameter value defining the at least one audio object position and at least one audio object energy proportion, wherein at least one audio object energy proportion associated with the at least one audio object position can be determined based on at least one further audio object energy proportion; receive information defining the at least one audio object position and at least one audio object energy proportion associated with the at least one object; and receive at least one parameter value defining the at least one audio object position and at least one audio object energy proportion associated with the at least one object.

The at least two audio signals may comprise at least two channels of a spatial audio signal.

According to a fourth aspect there is provided an apparatus for processing at least two audio signals and associated metadata, the apparatus comprising: means for obtaining the at least two audio signals, the at least two audio signals comprising at least one audio object portion and at least one non-audio object portion; means for obtaining the associated metadata, wherein the associated metadata is configured to define at least one audio object position and at least one audio object energy proportion; means for obtaining object position control information; means for determining mixing information based on the object position control information and the at least one audio object position and at least one audio object energy proportion; and means for processing the at least two audio signals based on the mixing information, wherein the processing is configured to enable the at least one object portion of a first of the at least two audio signals to be at least partially moved to a second of the at least two audio signals.

According to a fifth aspect there is provided a computer program comprising instructions [or a computer readable medium comprising program instructions] for causing an apparatus for processing at least two audio signals and associated metadata to perform at least the following: obtain the at least two audio signals, the at least two audio signals comprising at least one audio object portion and at least one non-audio object portion; obtain the associated metadata, wherein the associated metadata is configured to define at least one audio object position and at least one audio object energy proportion; obtain object position control information; determine mixing information based on the object position control information and the at least one audio object position and at least one audio object energy proportion; and process the at least two audio signals based on the mixing information, wherein the processing is configured to enable the at least one object portion of a first of the at least two audio signals to be at least partially moved to a second of the at least two audio signals.

According to a sixth aspect there is provided a non-transitory computer readable medium comprising program instructions for causing an apparatus for processing at least two audio signals and associated metadata to perform at least the following: obtain the at least two audio signals, the at least two audio signals comprising at least one audio object portion and at least one non-audio object portion; obtain the associated metadata, wherein the associated metadata is configured to define at least one audio object position and at least one audio object energy proportion; obtain object position control information; determine mixing information based on the object position control information and the at least one audio object position and at least one audio object energy proportion; and process the at least two audio signals based on the mixing information, wherein the processing is configured to enable the at least one object portion of a first of the at least two audio signals to be at least partially moved to a second of the at least two audio signals.

According to a seventh aspect there is provided an apparatus for processing at least two audio signals and associated metadata, the apparatus comprising: obtaining circuitry configured to obtain the at least two audio signals, the at least two audio signals comprising at least one audio object portion and at least one non-audio object portion; obtaining circuitry configured to obtain the associated metadata, wherein the associated metadata is configured to define at least one audio object position and at least one audio object energy proportion; obtaining circuitry configured to obtain object position control information; mixing information determining circuitry configured to determine mixing information based on the object position control information and the at least one audio object position and at least one audio object energy proportion; and processing circuitry configured to process the at least two audio signals based on the mixing information, wherein the processing is configured to enable the at least one object portion of a first of the at least two audio signals to be at least partially moved to a second of the at least two audio signals.

According to an eighth aspect there is provided a computer readable medium comprising program instructions for causing an apparatus for processing at least two audio signals and associated metadata to perform at least the following: obtain the at least two audio signals, the at least two audio signals comprising at least one audio object portion and at least one non-audio object portion; obtain the associated metadata, wherein the associated metadata is configured to define at least one audio object position and at least one audio object energy proportion; obtain object position control information; determine mixing information based on the object position control information and the at least one audio object position and at least one audio object energy proportion; and process the at least two audio signals based on the mixing information, wherein the processing is configured to enable the at least one object portion of a first of the at least two audio signals to be at least partially moved to a second of the at least two audio signals.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows a flow diagram of the operation of the apparatus shown in FIG. 1 according to some embodiments;

FIG. 3 shows schematically an example of the encoder as shown in FIG. 1 according to some embodiments;

FIG. 4 shows a flow diagram of the operations of the example encoder shown in FIG. 3 according to some embodiments;

FIG. 5 shows schematically an example of the decoder as shown in FIG. 1 according to some embodiments;

FIG. 6 shows a flow diagram of the operations of the example decoder shown in FIG. 5 according to some embodiments;

FIG. 7 shows schematically an example of the spatial synthesizer as shown in FIG. 5 according to some embodiments;

FIG. 8 shows a flow diagram of the operations of the example encoder shown in FIG. 7 according to some embodiments;

FIG. 9 shows schematically a further example of the spatial synthesizer as shown in FIG. 5 according to some embodiments;

FIG. 10 shows a flow diagram of the operations of the further example encoder shown in FIG. 9 according to some embodiments; and

FIG. 11 shows schematically an example device suitable for implementing the apparatus shown herein.

### EMBODIMENTS OF THE APPLICATION

The concept as discussed herein in further detail with respect to the following embodiments is related to parametric spatial audio rendering. In the following examples an IVAS codec is used to show practical implementations or examples of the concept. However it would be appreciated that the embodiments presented herein may be extended to other codecs without inventive input.

The concept as discussed herein in further detail in the following embodiments is one of providing individual audio object interaction within a suitable decoder/renderer even where the audio objects have been combined in the encoder and thus are not individually obtained (or were not transmitted separately).

Furthermore the embodiments described are configured such that they allow interactive rendering of audio objects even when the audio objects are combined with parametric spatial audio streams.

As such in some embodiments where the audio objects are received as individual audio signals (together with individual direction metadata), they can be straightforwardly rendered in an interactive manner. The direction can simply be modified based on, e.g., user input, and the renderer can render the audio object to the new direction.

However as discussed above there can be situations when the individual audio signals cannot be transmitted for all audio objects. This could be, for example, when the number of channels has to be reduced by merging the audio signals together (for example to two channels) and metadata is generated that indicates the relative energy proportions of the original audio objects at the mixture, to enable their spatial rendering at a later stage. This implementation of merging audio objects into a merged mix and then rendering them to various spatial audio outputs has been proposed in Spatial Audio Object Coding (SAOC).

When a spatial renderer is configured to render, for example, a 5.1 or binaural audio based on two transport audio channels (left and right) and spatial metadata, it is preferable that the right-side loudspeaker signals or right-ear binaural signals are predominantly based on the right transport audio channel, and correspondingly left-side loudspeaker signals or left-ear binaural signals are predominantly based on the left transport audio channel.

In some situations the position of audio objects may be moved during rendering. For example an audio object mixed on the left transport channel may be be moved to some direction or position on the right side of the listener. In such circumstances a renderer that is configured to render right-side sounds predominantly based on the right transport audio channel, performs poorly.

In SAOC and MPEG-H implementations and for object-only mixes the audio signals corresponding to the object are configured to be moved within the stereo mix, at some stage of the rendering process, by a mixing procedure for the stereo mix that moves the audio signals between left and right channels based on the audio object metadata and their movement.

Spatial Audio Object Coding (SAOC) as described in Herre, J. et al. (2012). “MPEG spatial audio object coding—the ISO/MPEG standard for efficient coding of interactive audio scenes”, Journal of the Audio Engineering Society, 60(9), 655-673 describes encoding objects as a downmix and spatial metadata and then decoding them while allowing rendering-time spatial adjustments. Audio objects are downmixed for example to a stereo track and a set of spatial metadata is extracted in time-frequency regions. This metadata comprises Object level differences (OLD), inter-object cross coherences (IOC), downmix channel level differences (DCLD), downmix gains (DMG) and object energies (NRG). Such a set of metadata provides the information to manipulate or render the multi-object mixture to a spatialized output. However, the metadata involved, and therefore the techniques related do not provide means to account for mixtures that prominently have non-object content.

Similarly, MPEG-H methods such as described in Herre, J., Hilpert, J., Kuntz, A., & Plogsties, J. (2015), “MPEG-H 3D audio—The new standard for coding of immersive spatial audio”, IEEE Journal of selected topics in signal processing, 9(5), 770-779 applies the methods as described in context of SAOC, however in an extended form that is referred to as SAOC-3D (such as described in Murtaza, A., Herre, J., Paulus, J., Terentiv, L., Fuchs, H., & Disch, S. (2015, October), “ISO/MPEG-H 3D audio: SAOC 3D decoding and rendering”, Audio Engineering Society Convention 139. Audio Engineering Society. These describe a system having audio objects and discrete surround audio channels at the same downmix stream, and effective decoding of them. However, this extension applies only to object-only coding as the original audio channels are conceptually close to static audio objects. In other words, SAOC-3D does not provide means to account for mixtures that prominently have non-object content, where “non-object content” is understood more broadly than loudspeaker channels, i.e., spatially static audio objects.

The concept as discussed in the embodiments herein expands on these implementations in that the transport audio signals do not only include audio objects, but also audio signals (and associated spatial metadata) from other sources. The other sources may, for example, be spaced microphone captured audio signals (which could be captured using a mobile device), downmixed 5.1 audio signals, or any other suitable audio input format.

The embodiments herein thus improve on the methods disclosed by SAOC in being configured to provide means to effectively handle object-movement of such signals. In particular the embodiments discussed herein are configured to enable a rendering of a “remainder” signal (in other words the part containing the other content, originating, for example, from the mobile device capture) and which is not significantly affected by object movement.

Hence the concept as discussed herein may be summarised as relating to interactive rendering of an audio signal having at least two channels and associated metadata to a spatialized output (e.g., 5.1 or binaural), where the audio signal is a mixture of audio objects and other audio content, and where the metadata having information of the (energetic) proportions of the audio objects and the other content (in time-frequency domain) as well as their spatial properties.

In such embodiments a method is provided that enables modification of the audio object positions of such a mixture at the renderer/decoder while providing high audio fidelity.

This can be implemented in some embodiments by determining mixing values that enable moving of the audio signal portions between the channels according to modification of the audio objects while aiming to not modify the non-object audio signal portions due to the object movement.

Furthermore in some embodiments this is achieved where the mixing values are determined based on the metadata related to directions of the audio objects; parameter(s) related to the desired modified positions of the audio objects; and metadata indicating the relative proportions of the audio object(s) and the other audio content at the at audio signals.

Additionally in some embodiments this implementation features processing the channels of the audio signal based on the channel mixing values, at least a part of the spatial metadata and the desired modified positions of the audio object(s) to obtain a spatial audio output with moved audio object positions.

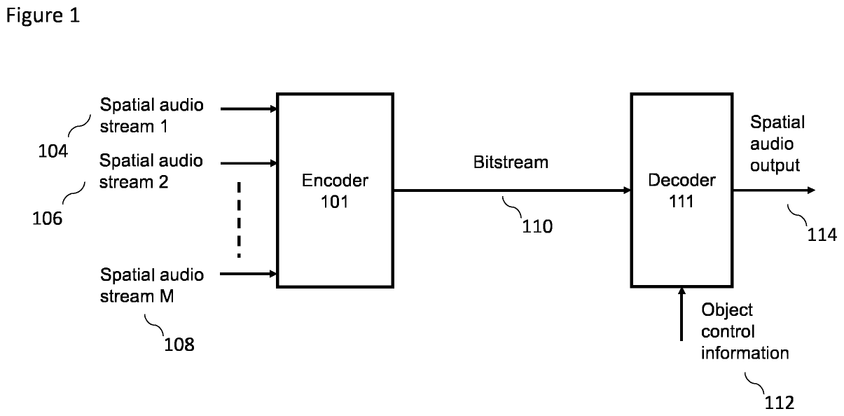

Before discussing the concept in further detail we will initially describe in further detail some aspects of spatial encoding, decoding and reproduction which may be implemented in some embodiments. For example with respect to FIG. 1 is shown an example system suitable for implementing embodiments as described herein. Thus for example FIG. 1 shows on the left hand side a spatial audio signal encoding environment.

The system comprises an encoder 101 which is configured to receive a number M of spatial audio signal streams. As shown in FIG. 1 is shown the spatial audio stream 1 104, spatial audio stream 2 106 and spatial audio stream M 108 which is input to the encoder 101. The encoder 101 can in some embodiments comprise an IVAS encoder, though in other embodiments other suitable encoders can be employed. The spatial audio streams 104, 106, 108 can in some embodiments be different kind of streams. For example the streams can be MASA streams, multichannel loudspeaker signal streams, and/or object streams. The encoder 101 is configured to generate an encoded bitstream 110. The encoded bitstream 110 in FIG. 1 is shown being passed to a separate decoder 111. However in some embodiments the bitstream may be stored in a suitable storage medium for later retrieval.

FIG. 1 shows on the right hand side a spatial audio signal decoding/rendering environment. The spatial audio signal decoding/rendering environment comprises a decoder 111. The decoder 111 is configured to receive or retrieve the encoded bitstream 110. Additionally the decoder 111 is configured to receive object control information 112. The decoder, which can be an IVAS decoder or any suitable format decoder (which matches the encoder) is configured to decode the bitstream 110 and render a spatial audio output 114 based on the object control information 112. The object control information 112 can for example comprise object position control information about the desired positions of the objects (for example the user of the decoder 111 may be able to set the positions or locations). The spatial audio output 114, in some embodiments, can be binaural audio signals.

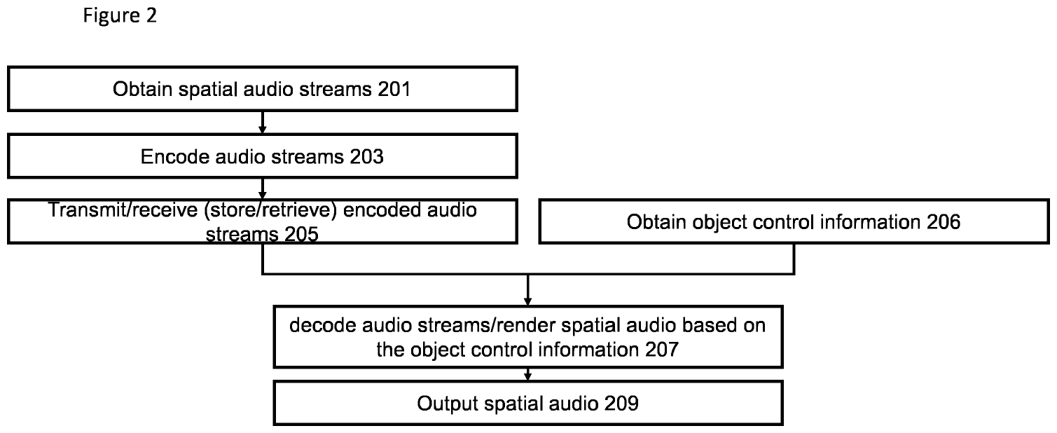

FIG. 2 shows, for example, a flow diagram of the operation of the example system as shown in FIG. 1.

Thus the spatial audio streams are initially obtained as shown in step 201.

Then the audio streams are encoded to generate the bitstream as shown in FIG. 2 by step 203.

The encoded bitstream is then transmitted to the decoder/received from the encoder (or stored/retrieved) as shown in FIG. 2 by step 205.

Additionally the object control information is obtained as shown in FIG. 2 by step 206.

The encoded audio streams in the form of the encoded bitstream is then decoded and a spatial audio output is rendered based on the object control information as shown in FIG. 2 by step 207.

Finally the spatial audio is output as shown in FIG. 2 by step 209.

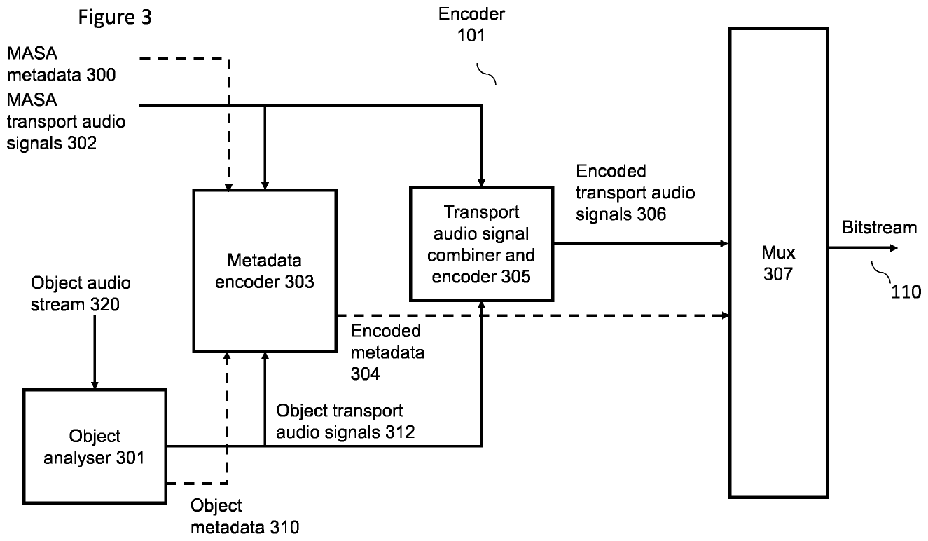

FIG. 3 shows an example encoder 101 as shown in FIG. 1 according to some embodiments. In this example, there are shown two input streams. The first input stream is a MASA stream, which comprises a MASA transport audio signals 302 and MASA metadata 300. The second input stream shown in FIG. 3 is an object audio stream 320 (containing a number of, for example N, objects).

It should be noted that in some embodiments there can be any suitable number of input streams and these two input streams are an example only.

The encoder 101 comprises an object analyser 301. The object analyser 301 has an input which receives the object audio stream 320 and is configured to analyse the object audio stream 320 and produce object transport audio signals 312 and object metadata 310.

The generation of the object audio stream 320 and object metadata 310 can be implemented using any suitable method, and the metadata can comprise any suitable metadata parameters. As an example, the object audio signals within the object audio stream 310 can be downmixed to a stereo downmix using amplitude panning based on the object directions, and the object metadata 310 configured to contain the object directions and time-frequency domain object-to-total energy ratios, which are obtained by analysing the energies of the objects in the frequency bands and comparing them to the total object energy of the band. The object transport audio signals 312 and the object metadata 310 can in some embodiments be passed to a metadata encoder 303 and the object transport audio signals 312 passed to a transport audio signal combiner and encoder 305.

In some embodiments the encoder 101 comprises a transport audio signal combiner and encoder 305. The transport audio signal combiner and encoder 305 is configured to obtain the MASA transport audio signals 302 and object transport audio signals 312 and combine and encode these inputs to generate encoded transport audio signals 306. The combination in some embodiments may be by summing them. In some embodiments, the transport audio signal combiner and encoder 305 is configured to perform other processing on the obtained transport audio signals or the combination of the transport signals. For example in some embodiments the transport audio signal combiner and encoder 305 is configured to adaptively equalize the resulting signals in order to have the same energy in the time-frequency domain for the combined signals as the sum of the energies of the MASA and object transport audio signals.

The encoding of the combined transport audio signals can employ any suitable codec. For example in some embodiments the transport audio signal combiner and encoder 305 is configured to encode the combined transport audio signals using a EVS or AAC codec.

The encoded transport audio signals 306 can then be output to a multiplexer or mux 307.

In some embodiments the encoder 101 comprises a metadata encoder 303. The metadata encoder 303 is configured to receive the MASA metadata 300 and the object metadata 310 (in some embodiments the metadata encoder 303 is further configured to receive the MASA transport audio signals 302 and the object transport audio signals 312). The metadata encoder 303 is configured to apply a suitable encoding to the metadata.

The implementation of the metadata encoding may be any suitable encoding method. A few examples of which are described hereafter.

As a first example of metadata encoding, the object-to-total energy ratios rₒ′(k, n, o) of the object stream and the direct-to-total energy ratios r_{M}′(k,n) of the MASA stream are modified based on the energies (which can be computed using the transport audio signals) of the streams,

$${r}_{o} ( k , n , o ) = \frac{{E}_{o} ( k , n )}{{E}_{o} ( k , n ) + {E}_{M} ( k , n )} {r}_{o}^{′} ( k , n , o )$$

$${r}_{M} ( k , n ) = \frac{{E}_{M} ( k , n )}{{E}_{o} ( k , n ) + {E}_{M} ( k , n )} {r}_{M}^{′} ( k , n )$$

where o=1, . . . , Nₒ is the object index an, Nₒ is the number of objects mixed to the transport audio signals, k is the frequency band index, n is the temporal frame index, Eₒ(k,n) is the estimated total energy of the object transport audio signals at frame n and band k, and E_{M}(k,n) is the estimated total energy of the MASA transport audio signals at frame n and band k. As a result, the energy ratios are related to the total energy of the mixed object and MASA transport audio signals (whereas as they were originally related to the separate transport audio signals). These energy ratios can then be encoded using a suitable energy-ratio encoding method (for example using methods described in GB application 2011595.2 and 2014392.1).

In some embodiments, the object-to-total energy ratios rₒ′(k,n,o) and the direct-to-total energy ratios r_{M}′(k,n) can be encoded without the modifications (e.g., using methods described above). Then values related to the ratio between Eₒ(k,n) and E_{M}(k,n) can be computed and encoded (e.g., object-to-total energy ratios, and/or MASA-to-total energy ratios, and/or MASA-to-object energy ratios, and/or object-to-MASA energy ratios). The methods described in the referenced applications above may also be applied here, or any other suitable methods. In this case, the modifications of the object-to-total energy ratios rₒ′(k,n,o) and the direct-to-total energy ratios r_{M}′(k,n) as described in the foregoing can be applied in the decoder.

Additionally, the directions of the object and the MASA streams can be encoded using any suitable encoding scheme, such as described in PCT applications WO2020089510, WO2020070377, WO2020008105, WO2020193865, WO2021048468.

The encoded metadata 304 is configured to be output to the multiplexer 307.

The encoder 101 can in some embodiments comprise a multiplexer or mux 307 which is configured to obtain the encoded metadata 304 and the the encoded transport audio signals 306 which is configured to multiplex them into a single bitstream 110 which is the output of the encoder 101.

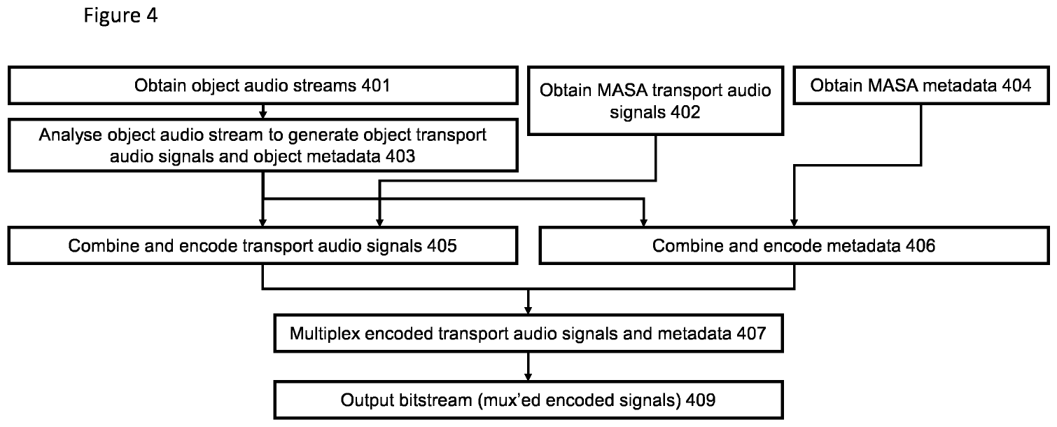

FIG. 4 shows a flow diagram of the operation of the example encoder as shown in FIG. 3.

As such in some embodiments the object audio streams are obtained as shown in FIG. 4 by step 401.

The object audio streams are then analysed to generate the object metadata and the object transport audio signals as shown in FIG. 4 by step 403.

Additionally the MASA transport audio signals are obtained as shown in FIG. 4 by step 402.

The MASA metadata is furthermore obtained as shown in FIG. 4 by step 404.

Having obtained the MASA transport audio signals and the object transport audio signals these are combined and encoded to generate encoded combined transport audio signals as shown in FIG. 4 by step 405.

Having obtained the MASA metadata and the object metadata these are combined and encoded to generate encoded combined metadata as shown in FIG. 4 by step 406.

Having generated the encoded combined metadata and the encoded combined transport audio signals then these can be multiplexed as shown in FIG. 4 by step 407.

Then the bitstream (the multiplexed encoded signals) are output as shown in FIG. 4 by step 409.

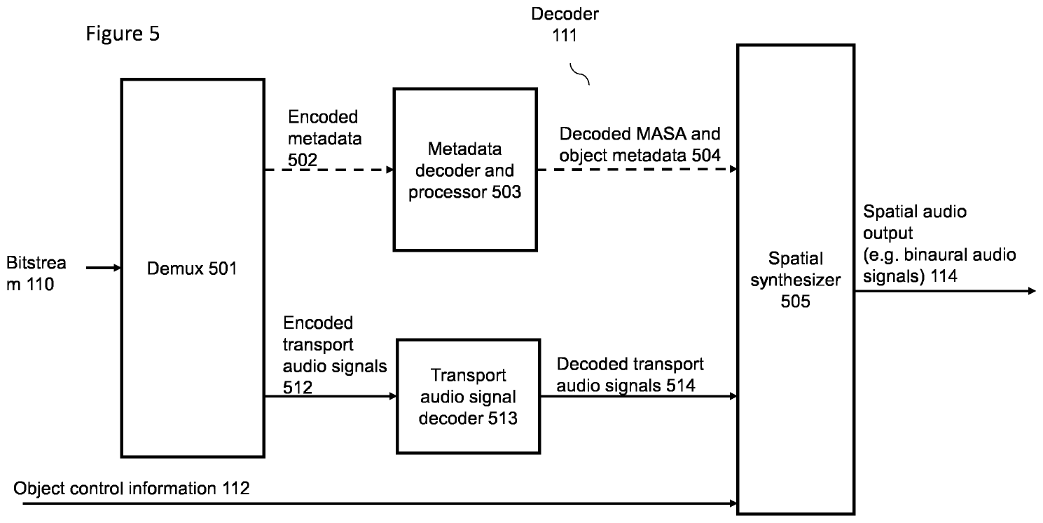

FIG. 5 shows an example decoder 111 as shown in FIG. 1 according to some embodiments. In this example, there is shown the bitstream which is obtained by the decoder 111.

The decoder 111 can in some embodiments comprise a demultiplexer or demux 501 which is configured to obtain the bitstream 110 and demultiplex it to encoded metadata 502, which is passed to a metadata decoder and processor 503 and encoded transport audio signals 512, which is passed to the transport audio signal decoder 513.

Furthermore the decoder 111 can in some embodiments comprise a transport audio signal decoder 513 configured to receive the encoded transport audio signals 512. The transport audio signal decoder 513 can then be configured to and decode the encoded transport audio signals 512 and generate decoded transport audio signals 514 which can be passed to a spatial synthesizer 505.

The decoder 111 furthermore, in some embodiments, comprises a metadata decoder and processor 503 configured to receive the encoded metadata 502. The metadata decoder and processor 503 furthermore is configured to decode and process the encoded metadata 502 and generate decoded MASA and object metadata 504. As mentioned above, there various ways to encode the metadata, and also different possible sets of metadata transmitted. Hence, the decoding and processing implemented in some embodiments can vary.

In some embodiments the decoded MASA and object metadata 504 can comprise the following parameters:
an object direction parameter denoted as DOA_{O}(n, o) (where o=1, . . . , Nₒ is the object index, Nₒ is the number of objects mixed to the transport audio signals, and n is the temporal frame index);
an object-to-total energy ratio parameter denoted as rₒ(k, n, o) (where k is the frequency band index);
MASA direction parameter DOA_{M}(k,n); and
MASA direct-to-total energy ratio parameter r_{M}(k,n), related to the directional part of the MASA-part of the audio signals.

In some embodiments other parameters may be generated, such as spread and surround coherence parameters for the MASA part.

It should be noted that the decoded MASA and object metadata 504 in some embodiments does not necessarily directly correspond to the original MASA metadata and object metadata (that were input to the metadata encoder as shown in the example encoder), as the original metadata was related to the separate transport audio signals, whereas the decoded metadata is related to the combined transport audio signals. Thus in some embodiments the metadata decoder and processor 503 is configured to employ processing in order to convert the metadata into a suitable form. This processing may be implemented in the encoder 101 (as was mentioned above), or it may be performed here in the decoder 111 (using, for example, the aforementioned MASA-to-total energy ratios and/or object-to-total energy ratios), or it may be performed elsewhere.

The decoded MASA and object metadata can be passed to the spatial synthesizer 505.

The decoder 111 in some embodiments comprises a spatial synthesizer 505. The spatial synthesizer 505 is configured to receive the decoded MASA and object metadata 504, the decoded transport audio signals 514 and the object control information 112. The spatial synthesizer 505 is then configured to generate the spatial audio signals 114 based on the the decoded MASA and object metadata 504, the decoded transport audio signals 514 and the object control information 112. The spatial audio signals 114 can then be output.

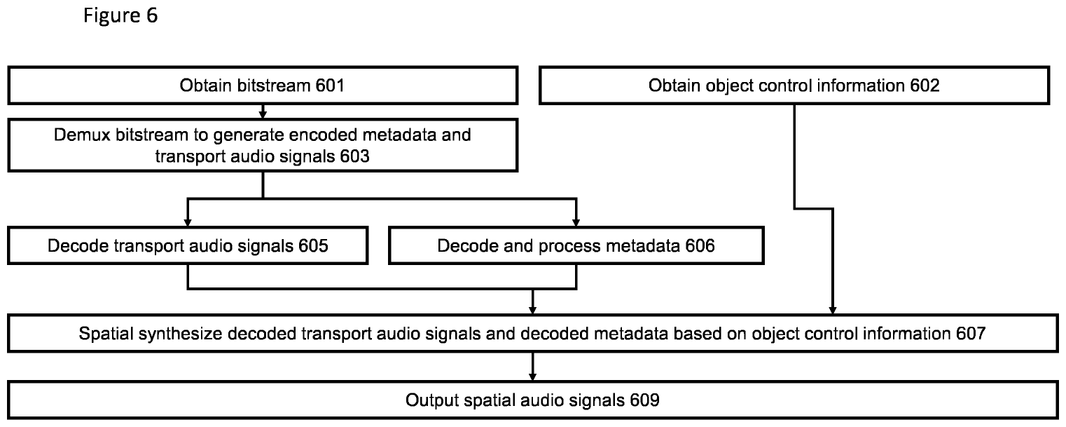

With respect to FIG. 6 is shown a flow diagram of the operations of the example decoder as shown in FIG. 5.

The bitstream is obtained as shown in FIG. 6 by step 601.

The bitstream is then demultiplexed to generate the encoded metadata and encoded transport audio signals as shown in FIG. 6 by step 603.

The encoded transport audio signals are then decoded as shown in FIG. 6 by step 605.

The encoded metadata furthermore is decoded as shown in FIG. 6 by step 606.

The object control information is obtained as shown in FIG. 6 by step 602.

The spatial audio signals are generated by spatial synthesizing the decoded transport audio signals, decoded metadata and object control information as shown in FIG. 6 by step 607.

Then the spatial audio signals are output as shown in FIG. 6 by step 609.

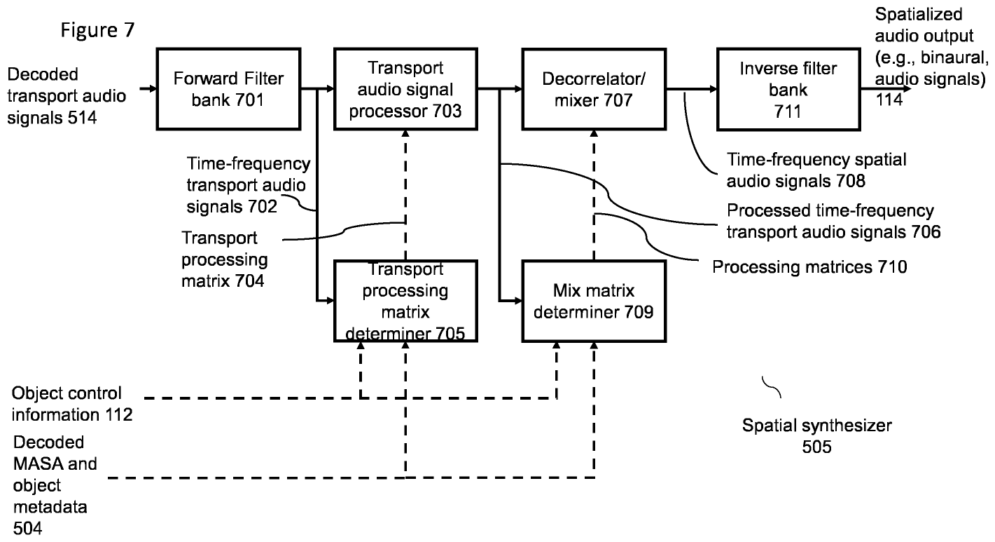

FIG. 7 shows in further detail a schematic view of an example spatial synthesizer 505 according to some embodiments.

The spatial synthesizer 505 is configured to receive the decoded transport audio signals 514, the object control information 112 and decoded MASA and object metadata 504.

In some embodiments the spatial synthesizer 505 comprises a forward filter bank 701. The forward filter bank 701 is configured to receive the decoded transport audio signals 514 and convert the signals to the time-frequency domain and generate time-frequency transport audio signals 702. For example the forward filter bank 701 comprises a short-time Fourier transform (STFT) or complex-modulated quadrature mirror filter (QMF) bank.

For example where the forward filter bank 701 is a STFT, the STFT can be configured so that the current and the previous audio frames are windowed and processed with a fast Fourier transform (FFT). The resultant output are time-frequency domain signals which are denoted as S(b, n, i), where b is the frequency bin and n is the temporal frame index, and i is the channel index. In the following, for simplicity of expression, we exemplify the most typical case of two transport audio channels, where we denote i=L for left channel and i=R for right channel. Nevertheless, the methods described below are straightforwardly extendable to more than two transport channels. The time-frequency transport audio signals 702 are passed to the transport processing matrix determiner 705 and the transport audio signal processor 703.

The spatial synthesizer 505, in some embodiments, comprises a transport processing matrix determiner 705. The transport processing matrix determiner 705 is configured to receive the Time-frequency transport audio signals 702, object control information 112 and the decoded MASA and object metadata 504. The transport processing matrix determiner 705 is configured to generate a mixing matrix that accounts for the movement of the audio objects at the transport audio signals. In this example there are exactly two transport audio signals, however, the methods herein are expandable to more than two transport signals.

The transport processing matrix determiner is thus to generate a matrix that, for example, is configured to move the left channel signals towards the right channel when there is an audio object predominantly at the left channel and when the object control information 112 indicates that it is moved towards the right side (for example, to 30 degrees right). Also, when the transport signals comprise non-object audio (or non-moved objects), the transport signals are preserved (and are modified as little as possible).

The transport processing matrix determiner 705 can in some embodiments be configured to receive the time-frequency transport signals 702 in frequency bands and determine their energies. The frequency bands can be grouped as one or more frequency bins of the time-frequency signals, so that each band k has a lowest frequency bin b_{low}(k) and a highest frequency bin b_{high}(k). The frequency band resolution, in context of an audio decoder, is typically such that follows the frequency resolution as defined by the spatial metadata (the decoded MASA and object metadata). The transport audio signal energies in some embodiments may be defined by

$$E ( k , n , i ) = {{\sum }^{{b}_{high} ( k )}}_{b = {b}_{low} ( k )} {\vert S ( b , n , i ) \vert}^{2}$$

The transport processing matrix determiner 705 is also configured to receive the decoded MASA and object metadata 504 which may comprise (at least) the following parameters (as described above): object direction DOA_{O}(n, o), object-to-total energy ratio rₒ(k, n, o), MASA direction DOA_{M}(k,n), and MASA direct-to-total energy ratio r_{M}(k,n).

The transport processing matrix determiner 705 can also receive the object control information 112. In this example embodiment, the object control information 112 comprises the intended object positions DOA_{O}′(n, o). For example the user of the decoder may have set the desired positions for each object. If for any object o, the intended object position is not received, then a default option can be defined that DOA_{O}′(n, o)=DOA_{O}(n, o).

The transport processing matrix determiner 705 is assumed to have the information of a panning function defining how the object signals have been mixed into the transport audio signals. The panning function can be configured to provide panning gains g(DOA, i) for each channel i for any DOA. For example, the panning function could be the tangent panning law for loudspeakers at ±30 degrees, such that any angle beyond this interval is hard panned to the nearest loudspeaker (except for the rear ±30 arc which could also use the same panning rule). Another panning function option is that the panning follows a cardioid pattern shape towards left or right directions. Any other suitable panning rule is an option, as long as the decoder knows which panning rule was applied by the encoder. This may be known (e.g., fixed), or signalled with the spatial metadata, e.g., as an index value to a table containing a set of pre-determined panning rules. Regardless of the panning rule, in the following, the panning gains are assumed to be limited between 0 and 1, and that the square sum of the panning gains is always 1. These requirements are true only for the example embodiment below. In some other embodiments, there may not be such requirements (or there may be some other requirements).

In some embodiments the transport processing matrix determiner 705 is further configured to apply the following steps to generate a transport processing matrix 704, for each frequency and time indices (k,n).

1. First, for each object o, the following steps are performed
1.1 Determining original and moved energetic pan values as

p(n,o,i)=(g(DOAₒ(n,o),i))²

p′(n,o,i)=(g(DOA′ₒ(n,o),i))²
1.2 Determining a centering factor

f(n,o)=max[0,2|p(n,o,L)−p′(n,o,L)|−1]
where the centering factor thus is non-zero when the energetic panning difference of input and output is more than 0.5. The centering factor is a limiting factor in the following formulas, so that the extreme left-right movements in the transport signals are avoided.
1.3 Modifying the moved energetic pan values by

p″(n,o,i)=0.5f(n,o)+(1−f(n,o))p′(n,o,i)
1.4 Formulating energetic object moving and preserving values

eneMoveObj(n,o,i)=max[0,p(n,o,i)−p″(n,o,i)]

enePreserveObj(n,o,i)=p(n,o,i)−eneMove(k,n,o,i)

Then, the transport processing matrix determiner 705 is configured to apply the following steps to determine the energetic moving and preserving values
2.1 The left and right energy values are normalized as

$${E}^{′} ( k , n , i ) = \frac{E ( k , n , i )}{E ( k , n , L ) + E ( k , n , R )}$$

2.2 Remainder energy values are formulated

$${E}^{″} ( k , n , i ) = max [ 0 , {E}^{′} ( k , n , i ) - {{\sum }_{o = 1}}^{{N}_{o}} {r}_{o} ( k , n , o ) p ( n , o , i ) ]$$

2.3 A further remainder value is formulated as

$$R ( k , n , i ) = max [ 0 , 1 - {{\sum }_{o = 1}}^{{N}_{o}} {r}_{o} ( k , n , o ) - {E}^{″} ( k , n , L ) - {E}^{″} ( k , n , R ) ]$$

3. The energetic preserve and moving values are then formulated by

$$eneMove ( k , n , i ) = {{\sum }_{o = 1}}^{{N}_{o}} {r}_{o} ( k , n , o ) eneMoveObj ( n , o , i )$$

$$enePreserve ( k , n , i ) = 0.5 R ( k , n , i ) + {E}^{″} ( k , n , i ) + {{\sum }_{o = 1}}^{{N}_{o}} {r}_{o} ( k , n , o ) enePreserveObj ( n , o , i )$$

The eneMove(k,n,i) and enePreserve(k,n,i) may in some embodiments be temporally smoothed, e.g., using an infinite impulse response (IIR) or finite impulse response (FIR) filter.

4. The transport processing matrix is then formulated by

$$T ( \text{} k , \text{} n ) = [ \begin{matrix}\text{} 1 / norm ( k , n , L ) & 0 \\ 0 & 1 / norm ( k , n , R )\end{matrix} ] [ \begin{matrix}\sqrt{enePreserve ( k , n , L )} & \sqrt{eneMove ( k , n , L )} \\ \sqrt{eneMove ( k , n , R )} & \sqrt{enePreserve ( k , n , R )}\end{matrix} ]$$

$$where$$

$$norm ( k , n , i ) = \sqrt{max [ 0 , enePreserve ( k , n , i ) + eneMove ( k , n , i ) ]}$$

The transport processing matrix 704 T(k,n) can then be output by the transport processing matrix determiner 705.

In some embodiments the spatial synthesizer 505 comprises a transport audio signal processor 703. The transport audio signal processor 703 is configured to receive the transport processing matrix 704 T(k,n) and the time-frequency transport signals 702 S(b, n, i).

$$s ( b , n ) = [ \begin{matrix}S ( b , n , L ) \\ S ( b , n , R )\end{matrix} ] ,$$

Then, denoting the transport audio signal processor 703 is configured to apply the matrix by

$${s}^{′} ( b , n ) = [ \begin{matrix}{S}^{′} ( b , n , L ) \\ {S}^{′} ( b , n , R )\end{matrix} ] = {g}_{T} ( k , n ) T ( k , n ) s ( b , n )$$

where g_{T}(k,n) are energy-preserving gains that are formulated by

$${g}_{T} ( k , n ) = \sqrt{\frac{{\sum }_{b = {b}_{low} ( k )}^{{b}_{high} ( k )} {( s ( b , n ) )}^{H} s ( b , n )}{{\sum }_{b = {b}_{low} ( k )}^{{b}_{high} ( k )} {( T ( k , n ) s ( b , n ) )}^{H} T ( k , n ) s ( b , n )}}$$

where the gain values g_{T}(k,n) may be upper limited, for example to 4.0 to avoid excessive gains.

The transport audio signal processor 703 in some embodiments is configured to output the processed time-frequency transport signals 706 s′(b,n).

In some embodiments the spatial synthesizer 505 comprises a mix matrix determiner 709. The mix matrix determiner 709 is configured to receive the processed time-frequency transport signals 706 s′(b,n), the object control information 112 and the decoded MASA and object metadata 504. The mix matrix determiner 709 is configured to determine a mixing matrix that, when applied to the processed time-frequency transport signals 706, enables a spatialized (e.g., binaural) output to be generated. In some embodiments the mix matrix determiner 709 is configured to determine first the processed time-frequency transport signal covariance matrix

$${C}_{x} ( k , n ) = {{\sum }^{{b}_{high} ( k )}}_{b = {b}_{low} ( k )} {s}^{′} ( b , n ) {( {s}^{′} ( b , n ) )}^{H}$$

the mix matrix determiner 709 then can determine an overall energy value Eₛ(k,n) as the sum of the diagonal values of Cₓ(k,n).

The mix matrix determiner 709 furthermore is configured to then determine a target covariance matrix, which consists of the levels and correlations for the output signal (and which in this example is a binaural signal). For determining a target covariance matrix in a binaural form, the mix matrix determiner 709 is configured to be able to determine (e.g., via lookup from a database) the head related transfer functions (HRTFs) for any direction of arrival (DOA). The HRTF can be denoted h(DOA,k) which is a 2×1 column vector having complex gains for left and right ears for band k and direction DOA. The corresponding HRTF covariance matrix is H(DOA,k)=h(DOA,k)h^{H}(DOA,k). The mix matrix determiner 709 can further be configured to have information of a diffuse-field covariance matrix C_{diff}(k) which may be formulated for example by selecting a spatially equally spaced set of directions DOA d where d=1 . . . D, and by

$${C}_{diff} ( k ) = \frac{1}{D} {\sum }_{d = 1}^{D} H ( DOA , k ) .$$

The target covariance matrix is determined by

$${C}_{y} ( k , \text{} n ) = [ \text{} {r}_{M} ( k , n ) H ( {DOA}_{M} ( k , n ) , k ) + ( 1 - {r}_{M} ( k , n ) - {{\sum }^{{N}_{o}}}_{o = 1} {r}_{o} ( k , n , o ) ) {C}_{diff} ( k ) + {\sum }_{o = 1}^{{N}_{o}} {r}_{o} ( k , n , o ) H ( {DOA}_{O} ( n , o ) , k ) ] {E}_{s} ( k , n )$$

In this example equation, there is one simultaneous MASA direction DOA_{M}(k,n) and Nₒ object directions DOA_{O}. In other embodiments, there may be more than one MASA direction, and those directions can be straightforwardly added to the equation above. Similarly, if the metadata indicates, the target covariance matrix could be built taking into account various other features such as coherent or incoherent spatial spreads, spatial coherences, or any other spatial features known in the art.

The mix matrix determiner can then be configured to employ any suitable method to generate a mixing matrix M(k, n) based on the matrices Cₓ(k, n) and C_{y}(k, n). Examples of such methods have been described in Vilkamo, J., Bäckström, T., & Kuntz, A. (2013), “Optimized covariance domain framework for time-frequency processing of spatial audio”, Journal of the Audio Engineering Society, 61(6), 403-411.

The formula provided in the appendix of the above publication can be used to formulate a mixing matrix M(k, n). In some embodiments a prototype matrix

$$Q = [ \begin{matrix}1 & 0 \\ 0 & 1\end{matrix} ]$$

is determined that guides the generation of the mixing matrix. In some embodiments a different prototype matrix can be used. For example in some embodiments a prototype matrix

$$Q = [ \begin{matrix}1 & 0.01 \\ 0.01 & 1\end{matrix} ]$$

where the zero values are replaced by some small number, in this example 0.01. The use of small number values rather than zero enables more stable spatial audio reproduction, as there is always some energy in both prototype signals.

The rationale of these matrices and the formula to obtain a mixing matrix M(k,n) based on them has been thoroughly explained in the above publication. In short, the method is such that provides a mixing matrix M(k, n) that when applied to a signal with a covariance matrix Cₓ(k,n) produces a signal with covariance matrix C_{y}(k, n), in a least-squares optimized way. In the present case the prototype matrix Q is the identity matrix or a practical implementation of the identity matrix with small non-zero terms for stability reasons, since the generation of appropriate prototype signals in some embodiments has been already generated by the transport audio signal processor 703. Having an identity prototype matrix means that the processing aims to produce an output that is as similar as possible to the input (i.e., with respect to the prototype signals) while obtaining the target covariance matrix C_{y}(k,n).

The mix matrix determiner 709 in some embodiments is configured to also determine a residual processing matrix Mᵣ(k,n). In some embodiments the processed transport signals do not have suitable inter-channel incoherence enabling rendering of incoherent outputs (e.g., in situation of ambience or spread sounds). The determination of the residual processing matrix was also described in the above cited publication. In short, the residual processing matrix can be determined, after all necessary matrix regularizations, in which way the processing of the transport signals with M(k, n) falls short in obtaining the target covariance matrix C_{y}(k,n). The residual processing matrix is formulated then so that it is able to process a decorrelated version of the processed transport signals s′(b,n) to obtain that missing portion of the target covariance matrix. In other words, the residual processing matrix achieves to produce a signal with a covariance matrix C_{y}(k,n)−M(k,n)Cₓ(k,n)M^{H}(k,n).

The mix matrix determiner 709 in some embodiments can be configured to provide the mixing matrix M(k,n) and the residual mixing matrix Mᵣ(k,n) as the processing matrices 710 to a decorrelator/mixer 707.

The spatial synthesizer 505 in some embodiments comprises a decorrelator/mixer 707. The decorrelator/mixer 707 is configured to receive the processed time-frequency transport signals 706 s′(b,n) and the processing matrices 710, and to generate the time-frequency spatial audio signals 708 y(b, n) by

y(b,n)=M(k,n)s′(b,n)+Mᵣ(k,n)D[s′(b,n)]

where D[s′(b,n)] denotes decorrelating the channels of s′(b,n) and band k is the band where bin b resides. The mixing matrices and/or the covariance matrices based on which the mixing matrices are based on may be smoothed over time. In the present example, the mixing matrices were formulated for every temporal index n. Sometimes the mixing matrices are formulated less frequently and interpolated over time. In that case, the covariance matrices may be determined with a larger temporal averaging.

The time-frequency spatial audio signals 708 y(b,n) are then output by the decorrelator/mixer 707.

It is understood that the mix matrix determiner 709 and decorrelator/mixer 707 shown herein represent only one way to synthesize a spatial output signal based on transport signals (in our example, the processed time-frequency transport signals) and spatial metadata, and other means are known in the literature.

In some embodiments the spatial synthesizer 505 comprises an inverse filter bank 711. The inverse filter bank 711 is configured to receive the time-frequency spatial audio signals 708, and applies an inverse transform corresponding to the transform applied by the forward filter bank 701. The result is a time domain spatial audio output 114, which is also the output of the spatial synthesizer 505 show in FIG. 5.

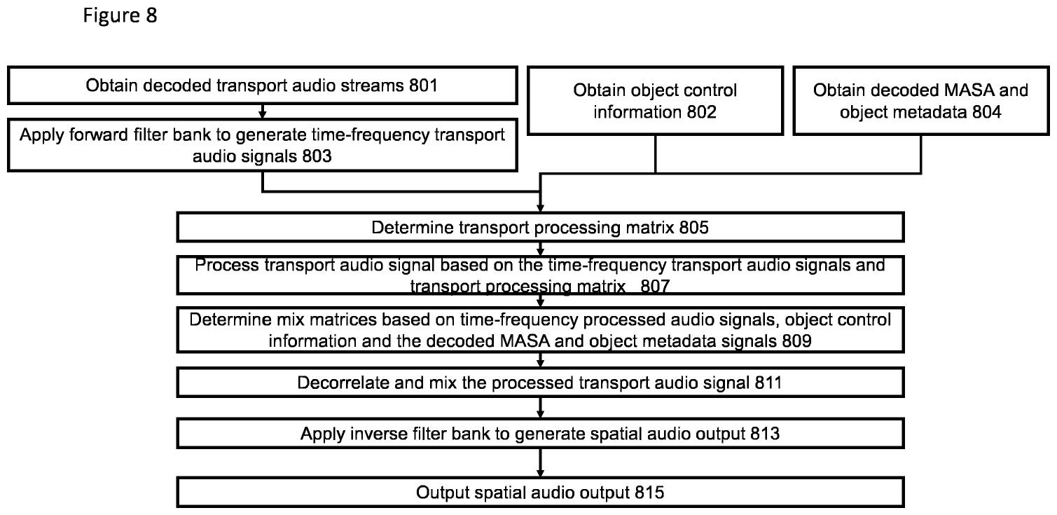

With respect to FIG. 8 is shown a flow diagram showing the operations of the spatial synthesiser 505 shown in FIG. 7.

Thus the decoded transport audio streams are obtained as shown in FIG. 8 by step 801.

A forward filter bank is configured to time-frequency domain transform the decoded transport audio streams to generate time-frequency transport audio signals as shown in FIG. 8 by step 803.

Furthermore the object control information is obtained as shown in FIG. 8 by step 802.

The decoded MASA and object metadata is furthermore obtained as shown in FIG. 8 by step 804.

The transport processing matrix is determined as shown in FIG. 8 by step 805.

The transport processing matrix is then applied to the time-frequency transport audio signals to generate a processed time-frequency transport audio signal as shown in FIG. 8 by step 807.

Then the mix matrices are determined as shown in FIG. 8 by step 809.

The mix matrices can then be applied to the processed transport audio signals as shown in FIG. 8 by step 811 to generate frequency domain spatial audio signals.

Then an inverse filter bank is applied to the frequency domain spatial audio signals as shown in FIG. 8 by step 813 to generate the spatial audio signals.

The spatial audio signals can then be output as shown in FIG. 8 by step 815.

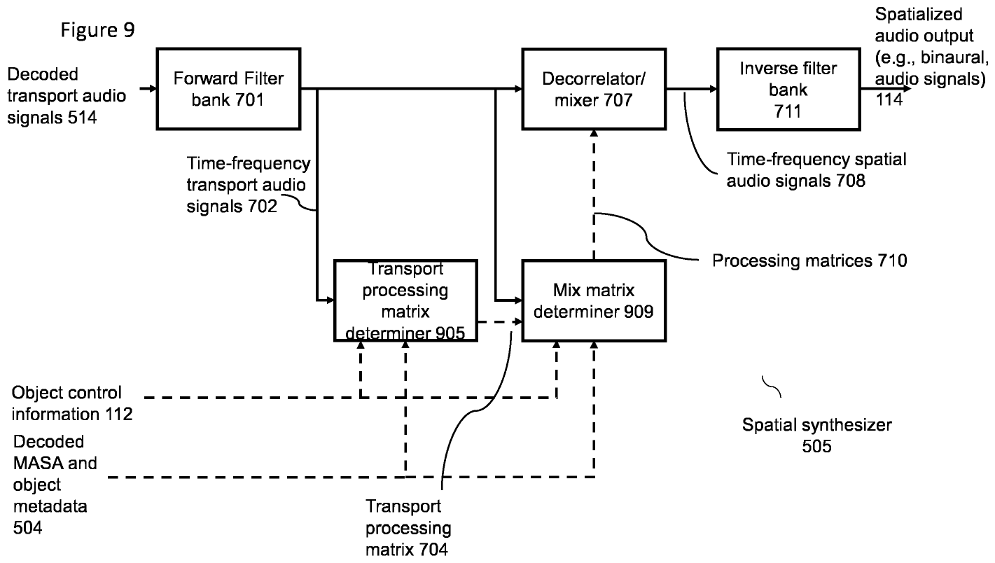

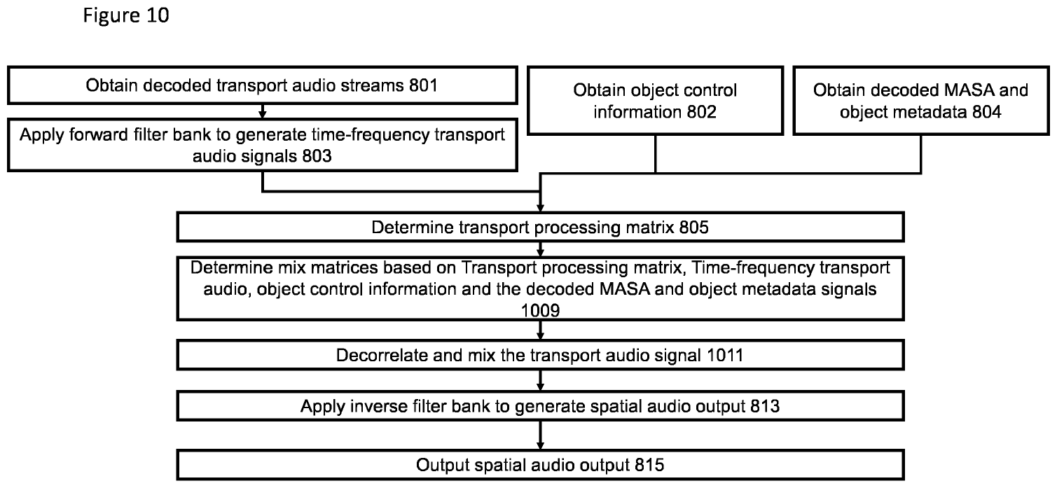

With respect to FIGS. 9 and 10 are shown a further example spatial synthesizer 505 and the flow diagram showing the operation of the further example spatial synthesizer. The difference between the example spatial synthesizers shown in FIGS. 7 and 9 is that the further example does not have the pre-processing step (the transport audio signal processor 703) to process the time-frequency transport signals and generate the processed time-frequency transport signals. In the further example spatial synthesizer the transport processing matrix determiner 905 is configured to generate the transport processing matrix 704 and pass it to a mix matrix determiner 909 (rather than as shown in FIG. 7 passing it to the transport audio signal processor).

Furthermore the further example spatial synthesizer comprises a mix matrix determiner 909. The mix matrix determiner 909 is configured to receive the transport processing matrix 704 from the transport processing matrix determiner 905 and set the prototype matrix as Q=T(k,n), when determining the mixing matrix M(k,n) for frequency band k and temporal index n. In these embodiments the movement of the audio objects in the stereo mix is combined with the determination of the actual processing matrices 710.

Furthermore, the decorrelator/mixer 707 is configured to process the time-frequency transport audio signals 702 instead of the processed time-frequency transport audio signals, and the mix matrix determiner 909 determines the covariance matrix of the time-frequency transport audio signals 702 instead of the processed time-frequency transport audio signals.

With respect to FIG. 10 is shown a flow diagram showing the operations of the further spatial synthesiser 505 shown in FIG. 9.

Thus the decoded transport audio streams are obtained as shown in FIG. 10 by step 801.

A forward filter bank is configured to time-frequency domain transform the decoded transport audio streams to generate time-frequency transport audio signals as shown in FIG. 10 by step 803.

Furthermore the object control information is obtained as shown in FIG. 10 by step 802.

The decoded MASA and object metadata is furthermore obtained as shown in FIG. 10 by step 804.

The transport processing matrix is determined as shown in FIG. 10 by step 805.

Then the mix matrices are determined based on the transport processing matrix, the time-frequency transport audio signals, the object control information and the decoded MASA and object metadata as shown in FIG. 10 by step 1009.

The mix matrices can then be applied to the time-frequency transport audio signals as shown in FIG. 10 by step 1011 to generate frequency domain spatial audio signals.

Then an inverse filter bank is applied to the frequency domain spatial audio signals as shown in FIG. 10 by step 813 to generate the spatial audio signals.

The spatial audio signals can then be output as shown in FIG. 10 by step 815.

In some embodiments, information related to the orientation (and/or the position) of the listener's head (i.e., head-tracking information) may be used when determining the transport processing matrix 704. For example, in the transport processing matrix determiner 705, the intended object positions DOA_{O}′(n,o) may be rotated based on the head tracking information, and the resulting rotated intended object positions may be used in the subsequent processing. Similarly, the MASA directions and the object directions can be rotated in the mix matrix determiner 709 in order to render the spatial audio according to the head-tracking information. It should be noted that, in some embodiments, the head-tracking processing itself may comprise additional processing to the transport audio signals (such as flipping the left and the right signals when the head has been rotated to look, e.g., behind), which may need to be taken into account, when determining the transport processing matrix 704 based on the head-tracking information.

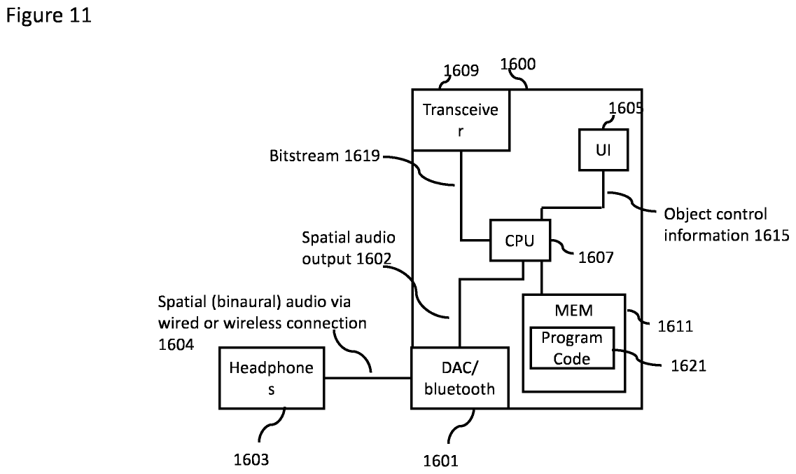

With respect to FIG. 11 an example electronic device which may be used as the computer, encoder processor, decoder processor or any of the functional blocks described herein is shown. The device may be any suitable electronics device or apparatus. For example in some embodiments the device 1600 is a mobile device, user equipment, tablet computer, computer, audio playback apparatus, a laptop, or a teleconferencing system.

In some embodiments the device 1600 comprises at least one processor or central processing unit (CPU or processor) 1607. The processor 1607 can be configured to execute various program codes such as the methods such as described herein.

The device 1600 furthermore comprises a transceiver 1609 which is configured to receive the bitstream and provide it to the processor 1607. Typically, the connection is wirelessly received data from a remote device or a server, however, in some embodiments the bitstream is received via a wired connection or read from a local memory of the device. The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The device may furthermore comprise a user interface (UI) 1605 which may display to the user an interface allowing moving the audio objects, for example, by dragging object icons to different positions. This object position information is the object control information 1615 provided to the processor 1607.

The device 1600 may further comprise memory (MEM) 1611 which is coupled to the processor 1607. In some embodiments the memory 1611 comprises the program code 1621 which is executed by the processor 1607. The program code may involve instructions to perform the operations of the spatial synthesizer described above. The processor 1607 can then be configured to output the spatial audio output, which in this example was a binaural output, to a digital to analogue converter (DAC)/Bluetooth 1601 converter.

The DAC/Bluetooth 1601 is configured to converts the spatial audio output to an analogue form if the headphones are conventional wired (analogue) headphones. For wireless connections, the DAC/Bluetooth 1601 may be a Bluetooth transceiver.

The DAC/Bluetooth 1601 block provides (either wired or wirelessly) the spatial audio to be played back with the headphones 1603 to the user. In some embodiments, the headphones 1603 may have a head tracker which may provide orientation and/or position information of the user's head to the processor 1607 of the rendering apparatus, so that user's head orientation is accounted for at the spatial synthesizer.

In some embodiments the remote device (not shown in FIG. 11) may generate the bitstream in various ways. In one situation, the remote device consists of multiple devices, for example, a device with a microphone array at a room with multiple participants, and multiple other devices with near-microphones (e.g., headset microphones) of remote participants. The microphone array may generate the MASA stream, and the remote participants may generate single-channel audio streams treated as object signals. Depending on the bit rates, these streams may be combined by a server, and conveyed to the device of FIG. 11.

In another example, the MASA stream is a captured spatial stream, for example, an audio recording at a sports event, and the object stream would originate from a commentator. For the present invention, the bitstream may originate from any kind of a setting.

The device of FIG. 11 may also capture the audio locally, and transmit it to a remote device, where the remote device may perform the rendering similarly to the device of FIG. 11.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media, and optical media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus, comprising:
at least one processor; and
at least one non-transitory memory storing instructions that, when executed with the at least one processor, cause the apparatus at least to:
obtain at least two audio signals, the at least two audio signals comprising at least one audio object portion and at least one non-audio object portion;
obtain metadata associated with the at least two audio signals, wherein the associated metadata is configured to define at least one audio object position and at least one audio object energy proportion;
obtain object position control information;
determine mixing information based on the object position control information, the at least one audio object position, and at least one audio object energy proportion; and
process the at least two audio signals based on the mixing information, wherein the processing is configured to enable the at least one object portion of a first of the at least two audio signals to be at least partially moved to a second of the at least two audio signals.

2. The apparatus as claimed in claim 1, wherein the object position control information comprises a modified position of the at least one audio object, and the one audio object energy proportion is configured to determine the mixing information determined mixing information is further based on the at least one audio object position, at least one audio object energy proportion, and the modified position of the at least one audio object.

3. The apparatus as claimed in claim 1, wherein the instructions, when executed with the at least one processor, cause the apparatus to determine at least one first mixing value based on the at least two audio signals, the object position control information, the at least one audio object position, and at least one audio object energy proportion.

4. The apparatus as claimed in claim 3, wherein the instructions, when executed with the at least one processor, cause the apparatus to process the at least two audio signals based on the at least one first mixing value.

5. The apparatus as claimed in claim 4, wherein the instructions, when executed with the at least one processor, cause the apparatus to determine at least one second mixing value based on the processed at least two audio signals, the object position control information, the at least one audio object position, and at least one audio object energy proportion.

6. The apparatus as claimed in claim 3, wherein the instructions, when executed with the at least one processor, cause the apparatus to determine at least one second mixing value based on the at least two audio signals, the at least one first mixing value, the object position control information, the at least one audio object position, and at least one audio object energy proportion.

7. The apparatus as claimed in claim 1, wherein the instructions, when executed with the at least one processor, cause the apparatus to process the at least two audio signals to:
generate a new first of the at least two audio signals based on combination of a first mixing information value applied to the first of the at least two audio signals and a second mixing information value applied to the second of the at least two audio signals; and
generate a new second of the at least two audio signals based on a third mixing information value applied to the second of the at least two audio signals.

8. The apparatus as claimed in claim 1, wherein the instructions, when executed with the at least one processor, cause the apparatus to process the at least two audio signals to:
generate a new first of the at least two audio signals based on combination of a first mixing information value applied to the first of the at least two audio signals and a second mixing information value applied to the second of the at least two audio signals; and
generate a new second of the at least two channels based on combination of a third mixing information value applied to the first of the at least two audio signals and a fourth mixing information value applied to the second of the at least two audio signals.

9. The apparatus as claimed in claim 1, wherein the instructions, when executed with the at least one processor, cause the apparatus to process the at least two audio signals such that the at least one non-audio object portion of the first of the at least two audio signals is not substantially moved.

10. The apparatus as claimed in claim 9, wherein the at least one non-audio object portion of the first of the at least two audio signals is not substantially moved and wherein the instructions, when executed with the at least one processor, cause the apparatus to determine energetic moving and preserving values based on remainder energy values.

11. The apparatus as claimed in claim 10, wherein the instructions, when executed with the at least one processor, cause the apparatus to determine the remainder energy values based on at least one of:
normalised object energy values determined from the at least two audio signals; or
energy values within the associated metadata.

12. The apparatus as claimed in claim 1, wherein the at least two audio signals are at least two transport audio signals.

13. The apparatus as claimed in claim 1, wherein the instructions, when executed with the at least one processor, cause the apparatus to at least one of:
obtain information defining the at least one audio object position, wherein at least one audio object energy proportion associated with the at least one audio object position can be determined based on at least one further audio object energy proportion;
obtain at least one parameter value defining the at least one audio object position and at least one audio object energy proportion, wherein at least one audio object energy proportion associated with the at least one audio object position can be determined based on at least one further audio object energy proportion;
receive information defining the at least one audio object position and at least one audio object energy proportion associated with the at least one object; or
receive at least one parameter value defining the at least one audio object position and at least one audio object energy proportion associated with the at least one object.

14. The apparatus as claimed in claim 1, wherein the at least two audio signals comprise at least two channels of a spatial audio signal.

15. A method, comprising:
obtaining at least two audio signals, the at least two audio signals comprising at least one audio object portion and at least one non-audio object portion;
obtaining metadata associated with the at least two audio signals, wherein the associated metadata is configured to define at least one audio object position and at least one audio object energy proportion;
obtaining object position control information;
determining mixing information based on the object position control information, the at least one audio object position, and at least one audio object energy proportion; and
processing the at least two audio signals based on the mixing information, wherein the processing enables the at least one object portion of a first of the at least two audio signals to be at least partially moved to a second of the at least two audio signals.

16. The method as claimed in claim 15, wherein the object position control information comprises a modified position of the at least one audio object, and determining the mixing information comprises determining the mixing information based on the at least one audio object position and at least one audio object energy proportion and the modified position of the at least one audio object.

17. The method as claimed in claim 15, wherein determining the mixing information comprises determining at least one first mixing value based on the at least two audio signals, the object position control information, the at least one audio object position, and at least one audio object energy proportion.

18. The method as claimed in claim 17, wherein the method further comprises processing the at least two audio signals based on the at least one first mixing value.

19. The method as claimed in claim 18, wherein determining the mixing information comprises determining at least one second mixing value based on the processed at least two audio signals, the object position control information, the at least one audio object position, and at least one audio object energy proportion.

20. The method as claimed in claim 17, wherein determining the mixing information comprises determining at least one second mixing value based on the at least two audio signals, the at least one first mixing value, the object position control information, the at least one audio object position, and at least one audio object energy proportion.

21-22. (canceled)

23. A non-transitory program storage device readable with an apparatus, tangibly embodying a program of instructions executable with the apparatus for performing the method of claim 15.
